(19) United States
(12) Patent Application Publication
(10) Pub. No.: US 2025/0357503 A1
(43) Pub. Date: Nov. 20, 2025

(54) FUEL CELL STACK

(71) Applicant: TOYOTA BOSHOKU KABUSHIKI KAISHA, Aichi-ken (JP)

(72) Inventors: Akihiro INUKAI, Okazaki-shi (JP); Satoshi KAWABE, Ichinomiya-shi (JP); Haruyuki AONO, Aichi-ken (JP); Kensuke DOI, Obu-shi (JP); Harutaka ODA, Toyota-shi (JP)

(73) Assignee: TOYOTA BOSHOKU KABUSHIKI KAISHA, Aichi-ken (JP)

(21) Appl. No.: 18/976,652

(22) Filed: Dec. 11, 2024

(30) Foreign Application Priority Data
Dec. 18, 2023 (JP) 2023-213081

(51) Int. Cl. H01M 8/0263; H01M 8/2457

(52) U.S. Cl. CPC H01M 8/0263; H01M 8/2457

(57) ABSTRACT

A fuel cell stack includes stacked single cells. Each of the single cells includes a power generating unit and two separators that sandwich the power generating unit. A surface of each of the separators facing the power generating has gas passages and ribs that are alternately arranged. The ribs extend along the gas passages. Each of the gas passages includes at least one first extension and a second extension. At least one of the gas passages includes an island-shaped branching rib arranged in a curved portion. The branching rib branches the gas passage into branching passages. The branching passages include an outer passage and an inner passage.

### CROSS-REFERENCE TO RELATED APPLICATIONS

This application is based upon and claims the benefit of priority from prior Japanese Patent Application No. 2023-213081, filed on Dec. 18, 2023, the entire contents of which are incorporated herein by reference.

### BACKGROUND

### 1. Field

The present disclosure relates to a fuel cell stack.

### 2. Description of Related Art

Conventionally, fuel cells are formed by stacking single cells. Each single cell includes a power generating unit with a membrane electrode assembly, and includes two separators that sandwich the power generating unit. The surface of each separator facing the power generating unit has gas passages and ribs that are alternately arranged. Reactant gas flows through the gas passages. The ribs extend along the gas passages.

Japanese Laid-Open Patent Publication No. 2006-147466 discloses a separator including a gas passage with corrugated passage grooves that extend in a corrugated pattern. The gas passage connects two corrugated passage grooves that are parallel to each other, and includes a fold-back portion that reverses the flow direction of reactant gas. The fold-back portion includes an embossed portion. At the fold-back portion, reactant gas flows in a direction that is different from the extending direction of the corrugated passage grooves.

When reactant gas is supplied in a direction different from the extending direction of the corrugated passage groove, the corrugated passage groove may be connected to a groove-shaped extension that extends in the direction different from the extending direction of the corrugated passage groove. To increase the amount of the reactant gas supplied to the power generating unit, multiple gas passages are preferably arranged in parallel in close proximity. When the gas passages are arranged in parallel in close proximity, the phase of the connection point of the corrugated passage groove with the extension, i.e., the position of the connection point with the extension relative to the corrugated passage groove, may differ for each gas passage. In such a case, the distance between two gas passages adjacent to each other is partially increased at the portion where the corrugated passage groove is connected to the extension. This may form a widened section in the rib extending along the two gas passages. The part of the power generating unit in contact with the widened section has an increased distance from the gas passage adjacent to the widened section. This limits situations in which reactant gas reaches that part. Accordingly, the amount of power generated by the power generating unit may partially decrease.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A fuel cell stack according to an aspect of the present disclosure includes stacked single cells. Each of the single cells includes a power generating unit including a membrane electrode assembly and two separators that sandwich the power generating unit. A surface of each of the separators facing the power generating has gas passages and ribs that are alternately arranged. Reactant gas flows through the gas passages. The ribs extend along the gas passages. Each of the gas passages includes at least one first extension extending in a first direction while meandering in a corrugated pattern and a second extension connected to an end of the first extension in the first direction and extending in a second direction that is different from the first direction. At least one of the gas passages includes an island-shaped branching rib arranged in a curved portion of the gas passage. The branching rib includes a portion where the first extension is connected to the second extension. The branching rib protrudes toward the power generating unit and branches the gas passage into branching passages. The branching passages include an outer passage extending outward from the curved portion and an inner passage extending inward from the curved portion, relative to the outer passage.

Other features and aspects will be apparent from the following detailed description, the drawings, and the claims.

### BRIEF DESCRIPTION OF THE DRAWINGS

FIG. 1 is a cross-sectional view of a fuel cell stack according to a first embodiment.

FIG. 2 is an exploded perspective view of the single cell shown in FIG. 1.

FIG. 3 is a plan view of the gas passages of each separator shown in FIG. 1.

FIG. 4 is an enlarged plan view of the curved portion of the separator shown in FIG. 3.

FIG. 5 is a cross-sectional view taken along line 5-5 of FIG. 4.

FIG. 6 is a cross-sectional view of a separator according to a comparative example.

FIGS. 7A to 7D are plan views of branching ribs according to a modification.

FIGS. 8A to 8C are plan views of branching ribs according to another modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

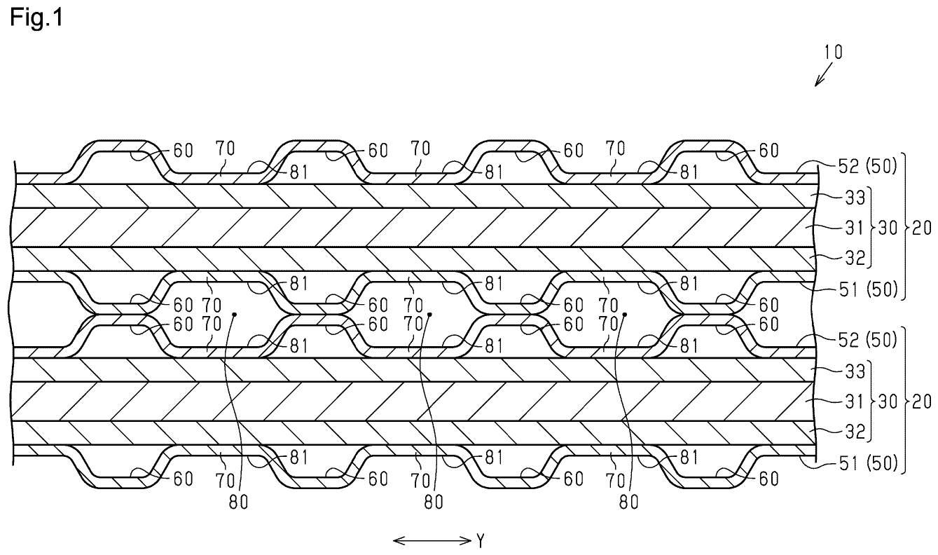

A fuel cell stack 10 according to an embodiment will now be described below with reference to FIGS. 1 to 6.

### Fuel Cell Stack 10

As shown in FIG. 1, the fuel cell stack 10 is formed by stacking single cells 20.

### Single Cell 20

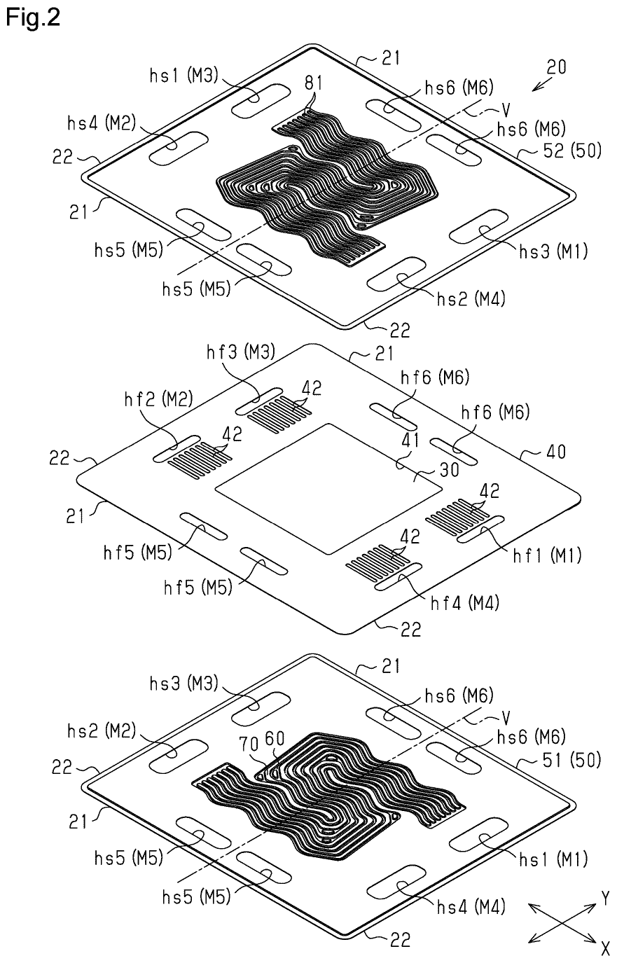

As shown in FIG. 2, the single cell 20 has the shape of, for example, a square plate.

That is, the single cell 20 includes two first sides 21, which extend parallel to each other, and two second sides 22, which are orthogonal to the first sides 21 and extend parallel to each other.

In the following description, the direction in which the single cells 20 are stacked will simply be referred to as the stacking direction. The direction in which the first sides 21 extend will be referred to as the X-axis direction, and the direction in which the second sides 22 extend will be referred to as the Y-axis direction. The stacking direction, the X-axis direction, and the Y-axis direction are orthogonal to each other.

The single cell 20 includes a fuel gas supply manifold M1, which supplies fuel gas to the single cell 20, a fuel gas discharge manifold M2, which discharges fuel gas to the outside of the single cell 20. Further, the single cell 20 includes an oxidant gas supply manifold M3, which supplies oxidant gas to the single cell 20, and an oxidant gas discharge manifold M4, which discharges oxidant gas to the outside of the single cell 20.

The manifolds M1 to M4 have, for example, elliptical shapes elongated in the Y-axis direction. The fuel gas supply manifold M1 and the oxidant gas discharge manifold M4 are located at the end of the single cell 20 on one side in the X-axis direction and arranged in this order from one side to the other side in the Y-axis direction. The fuel gas discharge manifold M2 and the oxidant gas supply manifold M3 are located at the end of the single cell 20 on the other side in the X-axis direction, which is opposite to the one side in the X-axis direction, and arranged in this order from the other side to the one side in the Y-axis direction. Fuel gas is, for example, hydrogen. Oxidant gas is, for example, air.

The single cell 20 includes two cooling medium supply manifolds M5, which supply cooling medium to the fuel cell stack 10, and two cooling medium discharge manifolds M6, which discharge cooling medium to the outside of the fuel cell stack 10. Each cooling medium supply manifold M5 and each cooling medium discharge manifold M6 have, for example, elliptical shapes elongated in the X-axis direction. The two cooling medium supply manifolds M5 are located at the end on the other side of the single cell 20 in the Y-axis direction and spaced apart from each other in the X-axis direction. The two cooling medium discharge manifolds M6 are located at the end of the single cell 20 on the one side in the Y-axis direction and spaced apart from each other in the X-axis direction. Cooling medium is, for example, water.

The single cell 20 includes a power generating unit 30, a frame 40, and two separators 50. The power generating unit 30 has the shape of a sheet. The frame 40 surrounds the outer edge of the power generating unit 30. The two separators 50 sandwich the power generating unit 30 and the frame 40 from the opposite sides in the stacking direction. The power generating unit 30 and the separator 50 have, for example, a square shape in a plan view. The frame 40 has, for example, a square frame shape in plan view.

### Power Generating Unit 30

As shown in FIG. 1, the power generating unit 30 includes a membrane electrode assembly 31, an anode-side gas diffusion layer 32, and a cathode-side gas diffusion layer 33. The anode-side gas diffusion layer 32 and the cathode-side gas diffusion layer 33 sandwich the membrane electrode assembly 31. The membrane electrode assembly 31 includes an electrolyte film, an anode electrode catalyst layer, and a cathode electrode catalyst layer, which are not shown. The anode electrode catalyst layer and the cathode electrode catalyst layer sandwich the electrolyte film. The anode-side gas diffusion layer 32 is laminated on the anode electrode catalyst layer. The cathode-side gas diffusion layer 33 is laminated on the cathode electrode catalyst layer.

Fuel gas is supplied to the anode-side surface of the power generating unit 30 through the fuel gas supply manifold M1. Oxidant gas is supplied to the cathode-side surface of the power generating unit 30 through the oxidant gas supply manifold M3. As a result, the power generating unit 30 generates power from the electrochemical reaction between the fuel gas and the oxidant gas.

In the fuel cell stack 10, each single cell 20 generates heat during the power generation of the power generating unit 30. Thus, the fuel cell stack 10 includes cooling passages 80, which will be described later. Cooling medium is supplied to the cooling passages 80 through the cooling medium supply manifolds M5.

### Frame 40

The frame 40 is made of an insulating resin material.

The frame 40 includes an accommodating hole 41 at its middle portion to accommodate the power generating unit 30.

The frame 40 includes through-holes hf1 to hf6, which respectively define manifolds M1 to M6, on the outer side of the accommodating hole 41.

The frame 40 includes slits 42 that extend through the frame 40 and are located

between the accommodating hole 41 and the through-holes hf1 to hf4. The slits 42 are arranged in parallel and spaced apart from each other in the Y-axis direction. Each slit 42 has an elongated oval shape extending in the X-axis direction. One end of each slit 42 is connected to one of through-holes hs1 to hs4 of the separator 50, which will be described later, in the stacking direction. The other end of each slit 42, which is opposite to the one end, is connected to the gas passage 60 of the separator 50, which will be described later, in the stacking direction. Each of the manifolds M1 to M4 is connected to the gas passage 60 through, for example, seven slits 42.

### Separator 50

The separator 50 is formed by pressing a metal (e.g., stainless steel, titanium alloy, or pure titanium) plate.

One of the two separators 50 is located on the anode-side surface of the power generating unit 30. The other separator 50 is located on the cathode-side surface of the power generating unit 30.

Hereinafter, the separator 50 located on the anode-side surface of the power generating unit 30 may be referred to as the anode separator 51, and the separator 50 located on the cathode-side surface of the power generating unit 30 may be referred to as the cathode separator 52.

The anode separator 51 and the cathode separator 52 have the same shape. The anode separator 51 and the cathode separator 52 are arranged in orientations that are inverted relative to each other about the virtual axis V, with respect to the power generating unit 30. The virtual axis V passes through the center of the separator 50 in the X-axis direction and extends in the Y-axis direction.

The separator 50 includes through-holes hs1 to hs6, which respectively define the manifolds M1 to M6. As described above, the anode separator 51 and the cathode separator 52 are arranged in orientations that are inverted with respect to the power generating unit 30. Thus, the through-hole hs1 of the anode separator 51 is connected to the through-hole hs3 of the cathode separator 52, and the through-hole hs2 of the anode separator 51 is connected to the through-hole hs4 of the cathode separator 52. Further, the through-hole hs3 of the anode separator 51 is connected to the through-hole hs1 of the cathode separator 52, and the through-hole hs4 of the anode separator 51 is connected to the through-hole hs2 of the cathode separator 52. Furthermore, the through-hole hs5 of the anode separator 51 is connected to the through-hole hs5 of the cathode separator 52, and the through-hole hs6 of the anode separator 51 is connected to the through-hole hs6 of the cathode separator 52.

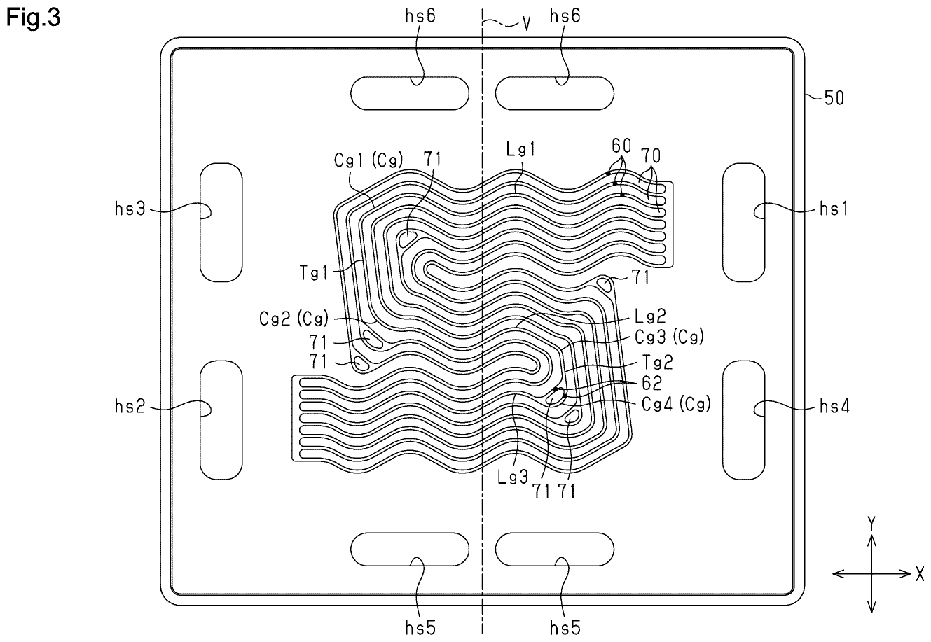

As shown in FIG. 3, groove-shaped gas passages 60 and ribs 70 are alternately arranged on the surface of the separator 50 that faces the power generating unit 30. Reactant gas flows through the gas passages 60. The ribs 70 extend along the gas passages 60. The separator 50 includes, for instance, eight gas passages 60 extending parallel to each other. Each gas passage 60 has a serpentine shape, extending in a meandering pattern from the through-hole hs1 to the through-hole hs2.

Fuel gas flows through the gas passages 60 of the anode separator 51 as reactant gas. Oxidant gas flows through the gas passages 60 of the cathode separator 52 as reactant gas. Reactant gas is supplied to the power generating unit 30 by flowing through the gas passages 60.

The reactant gas in the fuel cell stack 10 is supplied using, for example, a counter-flow method where fuel gas and oxidant gas flow in opposite directions.

Hereinafter, the upstream side in the flow direction of reactant gas through the gas passages 60 is simply referred to as the upstream side, and the downstream side in the flow direction is simply referred to as the downstream side.

Each gas passage 60 is formed into a substantially S-shape by connecting first extensions Lg1 to Lg3 to second extensions Tg1 and Tg2. Reactant gas flows sequentially through the first extension Lg1, the second extension Tg1, the first extension Lg2, the second extension Tg2, and the first extension Lg3.

The first extensions Lg1 to Lg3 are arranged in parallel and spaced apart from each other in the Y-axis direction. The first extensions Lg1 to Lg3 extend in the X-axis direction while meandering in a corrugated pattern. The X-axis direction is an example of a first direction.

The second extensions Tg1 and Tg2 extend straight, inclined relative to the virtual axis V, such that they are located toward the one side in the X-axis direction as they extend toward the downstream side. The direction in which the second extensions Tg1 and Tg2 extend is an example of a second direction.

The upstream end of the first extension Lg1 is connected to the through-hole hs1 through the slit 42 of the frame 40. The second extension Tg1 connects the downstream end of the first extension Lg1 to the upstream end of the first extension Lg2. The second extension Tg2 connects the downstream end of the first extension Lg2 to the upstream end of the first extension Lg3. The downstream end of the first extension Lg3 is connected to the through-hole hs2 through the slit 42. When reactant gas flows from the first extension Lg1 to the first extension Lg2 through the second extension Tg1 and flows from the first extension Lg2 to the first extension Lg3 through the second extension Tg2, the flow direction of the reactant gas reverses. Thus, the second extensions Tg1 and Tg2 each define a fold-back portion of the gas passage 60.

The gas passage 60 includes curved portions Cg1, Cg2, Cg3, and Cg4, each defining the fold-back portion of the gas passage 60. The curved portions Cg1, Cg2, Cg3, and Cg4 are sequentially located from the upstream side. Hereinafter, the curved portions Cg1, Cg2, Cg3, and Cg4 may be collectively referred to as the curved portion Cg.

The curved portion Cg1 includes a section where the first extension Lg1 is connected to the second extension Tg1. The curved portion Cg2 includes a section where the first extension Lg2 is connected to the second extension Tg1. The curved portion Cg3 includes a section where the first extension Lg2 is connected to the second extension Tg2. The curved portion Cg4 includes a section where the first extension Lg3 is connected to the second extension Tg2.

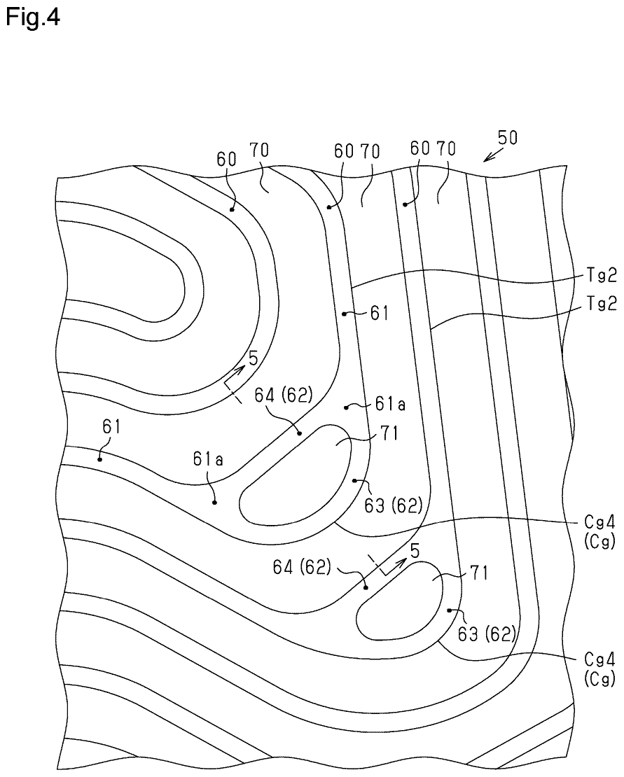

As shown in FIGS. 3 and 4, one of the curved portions Cg1 to Cg4 in at least one of the gas passages 60 includes a branching rib 71 that branches the gas passage 60 into two branching passages 62. That is, at least one of the gas passages 60 includes the branching rib 71 provided at the curved portion Cg. The branching rib 71 has an island shape. The branching rib 71 is separated from the rib 70 by a gap that extends around the entire perimeter of the branching rib 71. The shape of the branching rib 71 is substantially semicircular in plan view. The branching rib 71 protrudes toward the power generating unit 30. The branching rib 71 is in contact with the anode-side gas diffusion layer 32 or the cathode-side gas diffusion layer 33.

As shown in FIG. 3, in the present embodiment, out of the eight gas passages 60, six gas passages 60 each include one branching rib 71.

Hereinafter, the eight gas passages 60 are referred to as the first gas passage 60, the second gas passage 60, and so forth, in order of proximity of the first extension Lg1 to the through-hole hs6.

The first and second gas passages 60 each include the branching rib 71 at the curved portion Cg2. The third and fourth gas passages 60 each include the branching rib 71 at the curved portion Cg4. The fifth and seventh gas passages 60 do not include the branching rib 71. The sixth gas passage 60 includes the branching rib 71 at the curved portion Cg1. The eighth gas passage 60 includes the branching rib 71 at the curved portion Cg3. The placement of the branching ribs 71 in the gas passage 60, as well as the presence or absence of the branching ribs 71, is determined experimentally based on the pressure, flow rate, and the like of reactant gas flowing through each gas passage 60.

As shown in FIG. 4, the branching passage 62 includes an outer passage 63 and an inner passage 64. The outer passage 63 extends outward from the curved portion Cg. The inner passage 64 extends inward from the curved portion Cg, relative to the outer passage 63. The outer passage 63 extends in an arc-shaped curve. The inner passage 64 extends straight. The inner passage 64 has a shorter length than the outer passage 63.

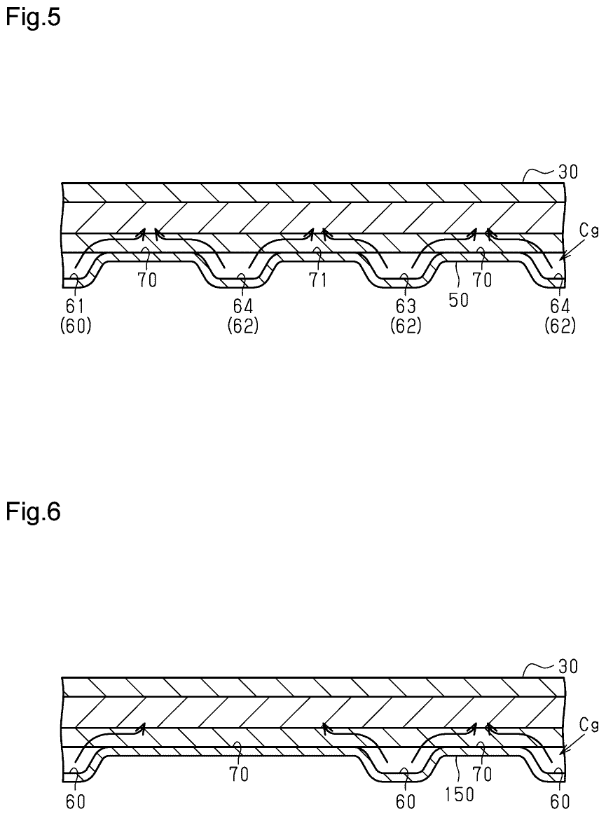

As shown in FIG. 5, the outer passage 63 and the inner passage 64 have the same cross-sectional flow area. Specifically, the outer passage 63 and the inner passage 64 have the same width and depth.

As shown in FIG. 4, the reactant gas flowing through a general section 61 of the gas passage 60, which is different from the branching passage 62, is distributed into two branching passages 62 by the branching rib 71 and then merges in the general section 61, which is located downstream of the two branching passages 62. That is, the general section 61 includes a merging section 61a, which includes a portion where the branching passages 62 are connected to each other, on the upstream and downstream sides of the branching rib 71. The entire cross-sectional flow area of the portion of the general section 61, excluding the merging section 61a, is the same as those of the outer passage 63 and the inner passage 64.

### Cooling Passage 80

As shown in FIG. 1, in the fuel cell stack 10, the anode separator 51 of one of two single cells 20 adjacent to each other in the stacking direction is in contact with the cathode separator 52 of the other single cell 20. The cooling passages 80, through which cooling medium flows, are formed between the anode separator 51 and the cathode separator 52 that are in contact with each other in the two adjacent single cells 20 in the stacking direction. A gasket (not shown) is arranged between the anode separator 51 and the cathode separator 52, which are in contact with each other, to provide a seal between the two single cells 20.

As shown in FIG. 2, the separator 50 includes cooling grooves 81 that define the cooling passages 80. The cooling grooves 81 are located on the surface of the separator 50 that is opposite to the surface on which the gas passages 60 are formed. Each cooling groove 81 is formed in conformance with the shape of the rear surface of the rib 70. The cooling groove 81 has a serpentine shape extending in a meandering pattern from the through-hole hs1 to the through-hole hs2. The cooling passage 80 is formed by the gap between the cooling groove 81 of the anode separator 51 and the cooling groove 81 of the cathode separator 52. The cooling medium supplied from the cooling medium supply manifold M5 flows through the cooling passage 80 and is then discharged from the cooling medium discharge manifold M6.

### Operation of Present Embodiment

As shown in FIG. 4, each curved portion Cg of the gas passage 60 is branched into two branching passages 62, including the outer passage 63 and the inner passage 64, by the branching rib 71. Thus, the inner passage 64 is located between the outer passage 63 and another gas passage 60, which is adjacent to the gas passage 60 that includes that outer passage 63. This ensures that even when the distance between the curved portions Cg of the gas passages 60 adjacent to each other increases, the inner passage 64 located inside each curved portion Cg limits an increase in the width of the portion of the rib 70 extending along the curved portion Cg.

As shown in FIG. 6, a separator 150 according to a comparative example does not include the branching passage 62 in the curved portion Cg. In this case, the portion of the rib 70 extending along the curved portion Cg may have an increased width. As indicated by the arrows in FIG. 6, this configuration limits situations in which reactant gas reaches the portion of the power generating unit 30 that is in contact with a relatively wide rib 70. This may lead to a partial reduction in the amount of power generated by the power generating unit 30.

In the separator 50 of the present embodiment, the curved portion Cg includes the branching passage 62. Thus, as indicated by the arrows in FIG. 5, reactant gas more easily reaches the portion of the power generating unit 30 that is in contact with the rib 70.

### Advantages of Present Embodiment

(1) At least one of the gas passages 60 includes the island-shape branching rib 71 provided at the curved portion Cg. The branching rib 71 branches the gas passage 60 into two branching passages 62. The two branching passages 62 respectively include the outer passage 63, which extends outward from the curved portion Cg, and the inner passage 64, which extends inward from the curved portion Cg, relative to the outer passage 63.

This configuration achieves the above-described operation and thus limits the partial reduction in the amount of power generated by the power generating unit 30.

(2) The two branching passages 62 have the same cross-sectional flow area.

This configuration limits differences in the flow rate of reactant gas in the two branching passages 62. This limits the partial reduction in the amount of power generated in the portion of the power generating unit 30 that faces the curved portion Cg.

(3) The outer passage 63 extends in an arc-shaped curve. The inner passage 64 extends straight.

For example, if the outer passage 63 and the inner passage 64 extend in a curved manner, the area of the merging section 61a, where the outer passage 63 and the inner passage 64 merge, may be enlarged. In this case, when the power generating unit 30 sinks in the merging section 61a, the cross-sectional flow area of the merging section 61a may decrease.

In the above-described configuration, compared to when the outer passage 63 and the inner passage 64 extend in a curved manner, an increase is limited in the area of the merging section 61a where the branching passages 62 merge. This limits the sinking of the power generating unit 30 at the merging section 61a.

(4) The second extension Tg1 connects the downstream end of the first extension Lg1 to the upstream end of the first extension Lg2. The second extension Tg2 connects the downstream end of the first extension Lg2 to the upstream end of the first extension Lg3.

In this configuration, the gas passage 60 is folded back by the first extension Lg1, the second extension Tg1, and the first extension Lg2. Further, the gas passage 60 is folded back by the first extension Lg2, the second extension Tg2, and the first extension Lg3. In the curved portion Cg formed at the fold-back portion of the gas passage 60, the degree of curvature is likely to increase. In this case, multiple curved portions Cg arranged in parallel are likely each to have a different degree of curvature. As a result, each rib 70 located between the curved portion Cg is likely to vary in width.

In the above-described configuration, the branching rib 71 is provided at each curved portion Cg. This limits an increase in the width of the rib 70 located between the curved portions Cg.

### Modifications

The present embodiment may be modified as follows. The present embodiment and the following modifications can be combined as long as they remain technically consistent with each other.

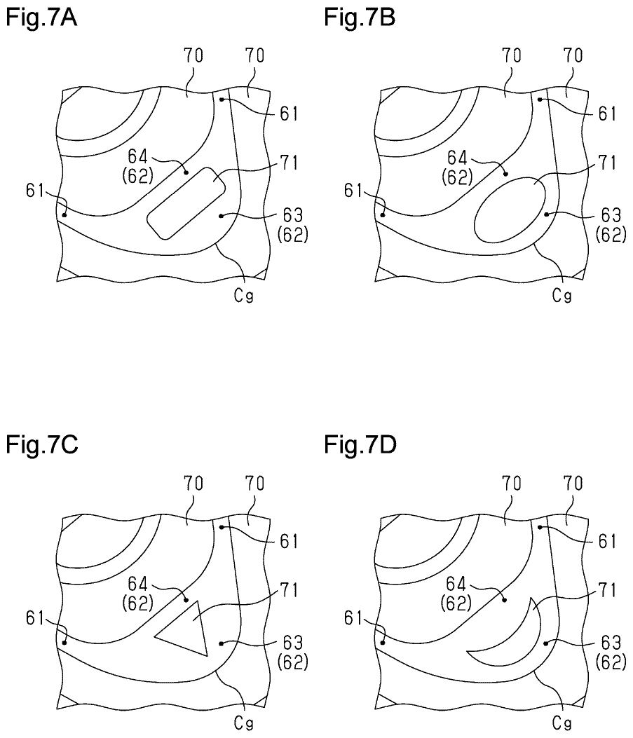

The branching rib 71 does not need to be semicircular in a plan view. For example, as shown in FIG. 7A, the branching rib 71 may have a rectangular shape with long sides extending in the flow direction. As shown in FIG. 7B, the branching rib 71 may have an elliptical shape. As shown in FIG. 7C, the branching rib 71 may have a triangular shape. As shown in FIG. 7D, the branching rib 71 may have a crescent shape. In these modifications, the cross-sectional flow areas of the outer passage 63 and the inner passage 64 are different from each other.

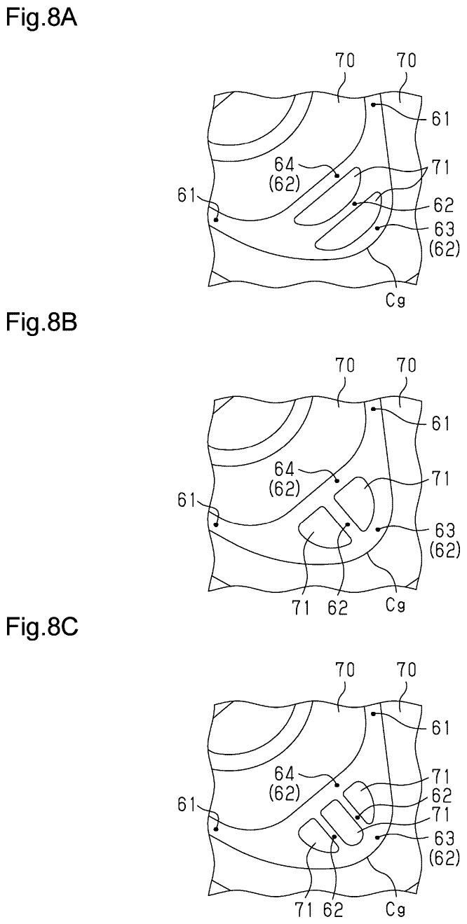

The curved portion Cg may include multiple branching ribs 71. In this case, the shapes of the branching ribs 71 may differ from each other. For example, as shown in FIG. 8A, the curved portion Cg may include multiple (two in this modification) branching ribs 71 that are arranged side by side in the width direction of the curved portion Cg. As shown in FIG. 8B, the curved portion Cg may include two branching ribs 71 arranged side by side in the flow direction. As shown in FIG. 8C, the curved portion Cg may include three branching ribs 71 arranged side by side in the flow direction. In these modifications, the curved portion Cg is branched into three or more branching passages 62, including the outer passages 63 and the inner passages 64, by the branching ribs 71. Thus, reactant gas is supplied to a wider area of the portion of the power generating unit 30 that faces the curved portion Cg. This limits a partial reduction in the amount of power generated by the power generating unit 30.

The cross-sectional flow area of the portion of the general section 61, excluding the merging section 61a, may be different from those of the outer passage 63 and the inner passage 64.

The second extensions Tg1 and Tg2 may extend in the direction that is orthogonal to the direction in which the first extensions Lg1, Lg2, and Lg3 extend, that is, the direction in which the virtual axis V extends.

The second extensions Tg1 and Tg2 may extend while meandering in a corrugated pattern.

The gas passage 60 does not need to have a serpentine shape as long as it includes the first extension Lg1 and the second extension Tg1. The gas passage 60 may include the first extension Lg1 facing the power generating unit 30 and two second extensions Tg1 that are connected to the upstream and downstream ends of the first extension Lg1, respectively. In this case, each second extension part Tg1 may be connected to any one of the manifolds M1 to M4.

The reactant gas in the fuel cell stack 10 may be supplied using, for example, a co-flow method where fuel gas and oxidant gas flow in the same direction in the first extensions Lg1, Lg2, and Lg3.

Each slit 42 does not necessarily need to extend through the frame 40, and may be formed as a groove that opens on one side in the thickness direction of the frame 40. In this case, the frame 40 may include the slits 42 between the accommodating hole 41 and the through-holes hf1 and hf2 on the surface facing the anode separator 51. Alternatively, the frame 40 may include the slits 42 between the accommodating hole 41 and the through-holes hf3 and hf4 on the surface facing the cathode separator 52.

The material of the separator 50 may be a carbon material or a composite material containing carbon and resin materials.

The separator 50 may be formed by machining or injection molding.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising stacked single cells, wherein
each of the single cells includes:
a power generating unit including a membrane electrode assembly; and
two separators that sandwich the power generating unit,
a surface of each of the separators facing the power generating unit has gas passages and ribs that are alternately arranged, wherein reactant gas flows through the gas passages, and the ribs extend along the gas passages,
each of the gas passages includes:
at least one first extension extending in a first direction while meandering in a corrugated pattern; and
a second extension connected to an end of the first extension in the first direction and extending in a second direction that is different from the first direction,
at least one of the gas passages includes an island-shaped branching rib arranged in a curved portion of the gas passage, wherein the branching rib includes a portion where the first extension is connected to the second extension, and the branching rib protrudes toward the power generating unit and branches the gas passage into branching passages, and
the branching passages include:
an outer passage extending outward from the curved portion; and
an inner passage extending inward from the curved portion, relative to the outer passage.

2. The fuel cell stack according to claim 1, wherein
the branching passages have the same cross-sectional flow area.

3. The fuel cell stack according to claim 1, wherein
the outer passage extends in an arc-shaped curve, and
the inner passage extends straight.

4. The fuel cell stack according to claim 1, wherein
the at least one first extension of each of the gas passages includes first extensions which are arranged in parallel to each other in the gas passage and in which the reactant gas flows in opposite directions, and
the second extension of each of the gas passages connects a downstream end, in the flow direction, of one of two of the first extensions arranged in parallel in the gas passage to an upstream end, in the flow direction, of the other one of the two of the first extensions.

5. The fuel cell stack according to claim 1, wherein
the branching rib is one of branching ribs arranged in the curved portion.
